(19) United States
(12) Patent Application Publication
(10) Pub. No.: US 2026/0196738 A1
(43) Pub. Date: Jul. 9, 2026

(54) ANTENNA, MOBILE COMMUNICATION BASE STATION AND USER DEVICE

(71) Applicant: Telefonaktiebolaget LM Ericsson (publ), Stockholm (SE)

(72) Inventors: Andreas Vollmer, Rosenheim (DE); Sertan Hastürkoglu, München (DE)

(21) Appl. No.: 19/133,008

(22) PCT Filed: Dec. 23, 2022
(86) PCT No.: PCT/EP2022/087785

§ 371 Date: May 27, 2025

(51) Int. Cl. H01Q 19/10; H01P 5/10; H01Q 1/24; H01Q 9/16

(52) U.S. Cl. CPC H01Q 19/10; H01P 5/10; H01Q 1/246; H01Q 9/16

(57) ABSTRACT

An antenna has a reflector, a first radiator with a radiator head and a support, as well as a second radiator. The radiator head comprises at least two radiation structures and the support is mounted to the reflector and supports the radiator head. A balun structure comprises a balun ground plane and a signal line. A shifting structure electrically connects the balun structure to the radiator head, comprising a connecting line and an inductive line, wherein the connecting line is capacitively coupled to the balun ground plane and extending to the radiator head, and the inductive line extends from the connecting line to the reflector ground plane and provides an inductivity. Further, a mobile communication base station and a user device are shown.

### TECHNICAL FIELD

The invention relates to an antenna, a mobile communication base station as well as to a user device.

### BACKGROUND

Multiband antennas are known in the art. In such antennas, a first array of first radiators designed for a first frequency band are interleaved with a second array of second radiators designed for a second frequency band. It is desirable that the radiators of the arrays have no influence on each other.

Usually, radiators designed as half wavelength dipoles are used. However, the first natural resonance does occur at a fourth of the wavelength of the design frequency, i.e. the average frequency of the respective frequency band. This means that a common mode resonance of a low-mid band radiator designed for the frequency band between 1.4 GHz and 2.7 GHZ lies fully within the frequency range of a low band radiator designed for the frequency band of 700 to 960 MHz. The resonances can occur over the dipoles but also including the balun structure as resonating element. Quarter wavelength resonances require a typically a shortened and an open end of the resonating line structure. These resonances are called common mode resonances.

Balun structures that shift the common mode resonance frequency to frequencies outside the lower frequency band are known, for example from U.S. Pat. No. 9,698,486 B2 and US 2021/0328365 A1.

However, the structures for shifting the common mode resonance known in the art need a lot of space on the support or on the reflector to which the support is mounted or have a small bandwidth.

### SUMMARY

It is thus an object of the invention to provide an antenna with a shifted common mode resonance frequency that is small in size, have a large bandwidth and easy to manufacture.

For this purpose, in an embodiment, an antenna, in particular for a mobile communication base station, is provided. The antenna comprises a reflector, a first radiator having a radiator head and at least one support, as well as a second radiator. The radiator head comprises at least two radiation structures forming at least one dipole, the reflector comprises a reflector ground plane, and the support is mounted to the reflector and supports the radiator head above the reflector. The second radiator is mounted to the reflector as well. A balun structure and a shifting structure are provided at least partly on the support, wherein the balun structure comprises a balun ground plane at the support and a signal line at the support. The shifting structure electrically connects the balun structure to the radiator head, comprising a connecting line and an inductive line, wherein the connecting line is capacitively coupled to the balun ground plane and extending to the radiator head, and the inductive line extends from the connecting line to the reflector ground plane and provides an inductivity.

By providing a shifting structure with an additional inductive line having an inductivity, the shift of the common mode frequency can be tuned versatilely resulting in a broad bandwidth while achieving a design that is both compact and simple to manufacture.

The first radiator is configured to emit and receive electromagnetic radiation in a first frequency band. For example, the first frequency band lies above 1.0 GHz, in particular the first frequency band is 1.4 GHz to 2.7 GHZ.

The second radiator is configured to emit and receive electromagnetic radiation in a second frequency band, different from the first frequency band. For example, the second frequency band lies below 1.0 GHz, in particular the second frequency band may be 617 MHz to 960 MHz.

For example, the inductive line has a characteristic impedance higher than the impedance of a grounding balun structure. The impedance of the inductive line is, for example, greater than 75 Ohms.

The balun structure is in particular configured to balance the signals to the at least one dipole. For example, the balun structure forms a Marchand balun.

The shifting structure is in particular configured for shifting a common mode resonance.

For example, the inductive line is galvanically coupled to connecting line with its first end and to the reflector ground plane with its second end.

In an embodiment, the balun ground plane comprises two separate balun ground portions and the shifting structure comprises two connecting lines and two inductive lines, wherein each radiation structure is associated with one of the connecting lines, one of the inductive lines and one of the ground portions, in particular wherein each radiation structure is electrically coupled to the associated connecting line, the associated connecting line being electrically coupled to the associated inductive line and the associated balun ground portion, providing a symmetric shift structure further increasing signal quality.

The signal line may be capacitively coupled to both balun ground portions.

For further improved signal quality, the connecting line may comprise a patch portion capacitively coupled to the balun ground plane, in particular the associated balun ground portion.

The patch portion may have a rectangular shape, with lengths of its sides within +-30% of one another.

In an embodiment, the inductive line is galvanically coupled to the connecting line, in particular to the patch portion, providing reliable coupling.

The inductive line is in particular galvanically coupled to the associated connecting line.

In an aspect, the inductive line comprises an inductive portion, in particular wherein the inductive line comprises parallel traces forming the inductive portion. This way, the inductivity provided by the inductive portion can be tuned easily by changing the length and amount of parallel traces.

For example, the parallel traces are part of a meander shape.

In an embodiment, the inductive line comprises a coupling portion, the coupling portion being capacitively coupled to the balun ground plane, in particular to the associated balun ground portion. By providing a capacitive coupling between the inductive line and the balun ground plane, a large shift of the common mode frequency is achieved in a structurally simple fashion.

For example, the coupling portion comprises a trace extending parallel to an edge of the balun ground plane, in particular wherein the distance between the trace and the edge is smaller than 1.5 mm and/or smaller than 1/100 of a wavelength of an average frequency of a frequency band of the radiation structures, achieving a reliable capacitive coupling.

The frequency band of the radiation structure is in particular the first frequency band.

In particular, the other portions of the inductive line are spaced further apart from the balun ground plane.

For further simplifying the design or reducing the space needed on the support, the balun structure may be located fully on the support or in part on the support and in part on the reflector; and/or the shifting structure may be located fully on the support or in part on the support and in part on the radiator head, in particular wherein the inductive line is located fully on the support.

In an embodiment, the support comprises a carrier being a dielectric, in particular a foil or a printed circuit board, the carrier having two surfaces, wherein the balun structure and the shifting structure are applied to the surfaces of the carrier, in particular as metallizations. This way, a reliable and cost efficient way of manufacturing the support is provided.

The carrier may be multilayered.

For further improved signal characteristics, the two surfaces may be a ground surface and a signal surface, wherein the balun ground plane may be provided on the ground surface, the connecting line of the shifting structure may be provided on the signal surface, and/or the inductive line of the shifting structure may be provided on the ground surface or the signal surface.

In particular, the ground surface and the signal surface are opposite surfaces, e.g. surfaces of the same layer of a material of the carrier.

The balun ground plane is, for example, located at least partially on the ground surface and/or the signal line is located at least partially on the signal surface.

The balun ground plane may be located between the two inductive lines, in particular the capacitive coupling portions of the inductive lines.

For a reliable connection, the inductive line may be galvanically coupled to the connecting line by a via extending through the carrier, if they are located on different sides of the carrier.

In an aspect, the connecting line, in particular the patch portion, and the balun ground plane overlap in a projection perpendicular to the carrier, providing a well defined capacitive coupling.

In an embodiment, the radiator comprises four radiation structures on the radiator head forming two dipoles and two supports, wherein each support is associated with one of the dipoles, in particular wherein the supports are arranged perpendicular to one another. This way, a dual polarized radiator is provided.

For example, each dipole is electrically connected to the balun structure and the shifting structure of the associated support.

In an aspect, the antenna comprises a plurality of first radiators forming a first array and/or a plurality of second radiators forming a second array, providing a multiband array antenna.

For the above mentioned purpose, in an embodiment, further a mobile communication base station is provided, the base station having at least one antenna as described above.

Further, for the above mentioned purpose, in an embodiment, a user device for mobile communication is provided having at least one antenna as described above.

The features and advantages described with respect to the antenna also apply to the base station and/or the user device and vice versa.

### BRIEF DESCRIPTION OF THE DRAWINGS

Further features and advantages will be apparent from the following description as well as the accompanying drawings, to which reference is made. In the drawings:

FIG. 1 shows a mobile communication base station according to an embodiment of the invention with an antenna according to an embodiment of the invention and a user device according to an embodiment of the invention with an antenna according to an embodiment of the invention,

FIG. 2 shows an enlarged view of one second radiator and four first radiators of the antenna according to FIG. 1,

FIG. 3 shows an enlarged view of one of the first radiators of FIG. 2,

FIGS. 4, 5 show a front view and a back view, respectively, of the support of the radiator of FIG. 3 without the carrier,

FIG. 6 shows an equivalent circuit of the radiator of FIG. 3 in a schematic front view, and

FIG. 7 shows a front view of the support of a radiator of an antenna according to a second embodiment of the invention.

### DETAILED DESCRIPTION

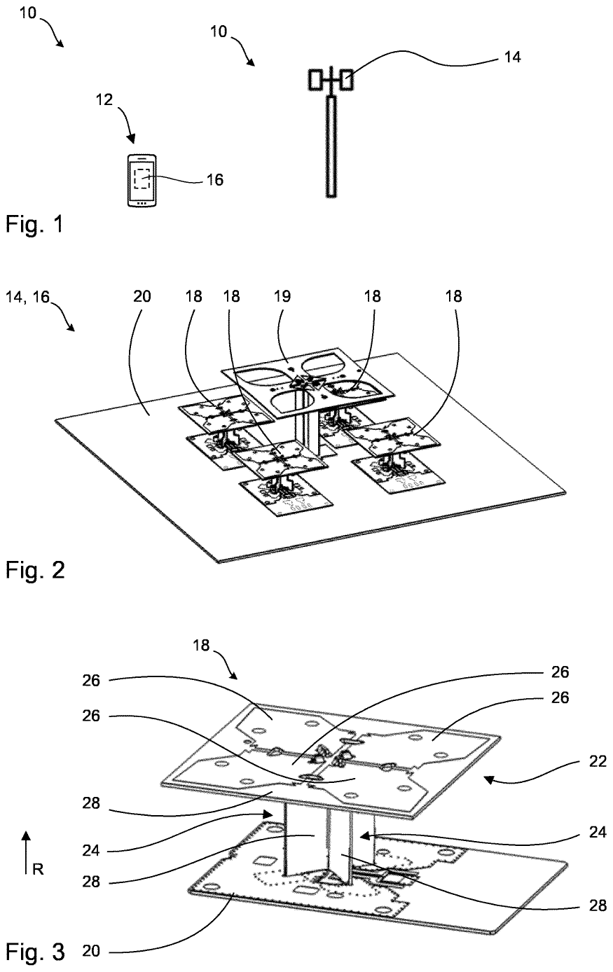

FIG. 1 shows an embodiment of a mobile communication base station 10 and an embodiment of a user device 12.

The mobile communication base station 10 has a plurality of antennas 14 for providing speech and data connections to user devices. Mobile communication base stations 10 are also referred to as mobile communication cell sites.

The mobile communication base station 10 may be an access network node of a radio access network of a telecommunication network, or any other similar 3rd Generation Partnership Project (3GPP) access nodes or non-3GPP access points.

Moreover, as will be appreciated by those of skill in the art, an access a network node is not necessarily limited to an implementation in which a radio portion and a baseband portion are supplied and integrated by a single vendor. Thus, it will be understood that network nodes include disaggregated implementations or portions thereof.

For example, in some embodiments, the mobile communication base station 10 is an Open-RAN (ORAN) network node. An ORAN network node is a node in the telecommunication network that supports an ORAN specification (e.g., a specification published by the O-RAN Alliance, or any similar organization) and may operate alone or together with other nodes to implement one or more functionalities of any node in the telecommunication network, including one or more network nodes and/or core network nodes.

Examples of an ORAN network node include an open radio unit (O-RU), an open distributed unit (O-DU), and an open central unit (O-CU).

The antenna 14 of the mobile communication base station 10 is a multiband antenna to provide speech and data connections in various frequency bands.

The user device 12 has an antenna 16 and may be a mobile phone, a laptop computer, or the like. The antenna 16 of the user device 12 is also a multiband antenna allowing a speech and/or data connection to the mobile communication base station 10 and/or to a communication satellite.

As shown in FIG. 2, exemplarily depicting a radiator for a mobile communication base station 10, both antennas 14, 16 have a plurality of first electromagnetic radiators 18 and a plurality of second radiators 19, even though only one is shown in FIG. 2.

The first radiators 18 (called first radiators 18 only for differentiation) form a first array designed for a first frequency band. Thus, the first radiators 18 are designed to transmit and receive electromagnetic waves in the first frequency band.

Likewise, the second radiators 19 form a second array for a second frequency band. Thus, the second radiators 19 are designed to transmit and receive electromagnetic waves in a second frequency band.

The first radiators 18, in particular the first array, and the second radiators, in particular the second array, are interleaved with one another.

The first frequency band lies above the second frequency band, in particular fully, i.e. not overlapping with the second frequency band.

For example, the first frequency band lies above 1.0 GHz, in particular the first frequency band is 1.4 GHz to 2.7 GHZ.

For example, the second frequency band lies below 1.0 GHZ, in particular the second frequency band may be 617 MHz to 960 MHz.

The first radiators 18 and the second radiators 19 are mounted on a reflector 20, serving as the common reflector for both types of radiators 18, 19.

FIG. 3 shows one of first radiators 18 mounted to the reflector 20.

Directional terms like “up”, “down”, “above”, “vertical”, etc. are to be understood with respect to the radiation direction R of the radiator. “Sideways” or “horizontal” is to be understood as a direction perpendicular to the radiation direction R.

The radiator 18 comprises a radiator head 22 and two supports 24.

The radiator head 22 has four radiation structures 26 forming a dipole arm each. The radiation structures 26 are arranged in a 2×2 grid, wherein diagonally opposite radiation structures 26 form one dipole.

For example, the radiator head 22 is a dual-polarized dipole, in particular with one +45-degree and one −45-degree single-polarized dipole. Each single-polarized dipole comprises two dipole arms. The radiation structures 26 may also be formed as a flat metallic area, also forming a loop or containing openings.

The radiator head 22 is mounted above the reflector 20 by means of the supports 24.

Each support 24 comprises a mechanical carrier 28 for mechanically supporting the radiator head 22 as well as a balun structure 30 and a shifting structure 32. The balun structure 30 and the shifting structure 32 are not shown in FIG. 3 for simplicity.

The carriers 28 of the supports 24 both extend perpendicular from the reflector 20. With respect to each other, the carriers 28 are arranged perpendicular to one another and/or cross one another.

The carrier 28 may be a substrate of a dielectric material. For example, the substrate is a printed circuit board.

It is also conceivable that the carrier 28 is one or more foils carrying the balun structure 30 and the shifting structure 32.

In the shown embodiment, the carrier 28 has two surfaces, namely a signal surface S and a ground surface G.

It is conceivable that the carrier 28 is multilayered, e.g. a multilayered substrate. In this case, the carrier 28 comprises more than two surfaces. In multilayered substrates, inner surfaces may be referred to as layers.

The balun structure 30 and the shifting structure 32 may be metallizations deposited on the respective surface of the carrier 28 using deposition techniques as known in the art.

In the same way, the radiator head 22 comprises a carrier 28 with the radiation structures 26 applied to the surface of it.

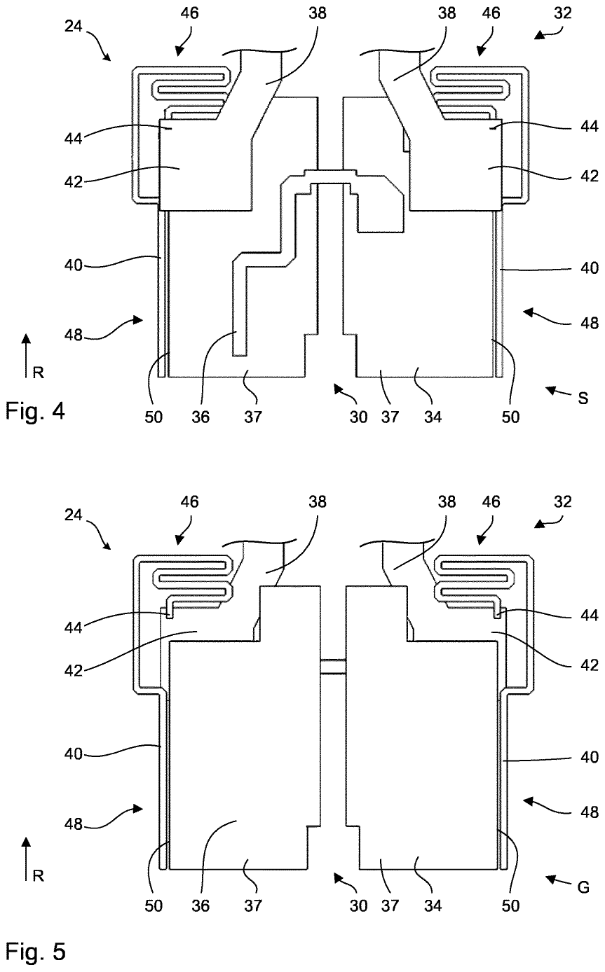

FIGS. 4 and 5 shows one of the supports 24 in a front view, i.e. onto the signal surface S, and in a back view, i.e. onto the ground surface G, respectively. In both figures, the carriers 28 are not shown, thus the metallizations on both surfaces S, G can be seen.

In particular, the balun structure 30 and the shifting structure 32 of the supports 24 are identical so that only one support 24 is discussed in the following.

The balun structure 30 and the shifting structure 32 are electrically connected to the radiation structure 26 of one of the dipoles.

The balun structure 30 comprises a balun ground plane 34 and a signal line 36.

The balun structure 30 forms a Marchand balun as known in the art.

The balun ground plane 34 and the signal line 36 are arranged on opposite sides of the carrier 28. For example, the signal line 36 is located on the signal surface S and the balun ground plane 34 is located on the ground surface G.

The balun ground plane 34 comprises two balun ground portions 37 arranged side by side, each one associated with a different one of the radiation structures 26 of the corresponding dipole.

The balun ground portions 37 are separated by a vertical gap between them and each of the ground portions 37 extends from the lower end of the support 24 upwards.

As best seen in FIG. 5, the balun ground portions 37 each comprise an outer edge 50, i.e. an edge facing away from the other ground portion 37 of the same balun ground plane 34.

In the assembled state, both balun ground portions 37 are electrically connected to the reflector 20, more precisely galvanically or capacitively coupled to the reflector ground plane of the reflector 20.

The signal line 36 extends from the lower end of the support 24 in the region of one of the balun ground portions 37 upwards, and then partly sideways across the gap into the region of the other balun ground portion 37. There, the signal line 36 ends in a patch.

It is also conceivable that parts of the balun ground plane 34, i.e. parts of the balun ground portions 37, and/or parts of the signal line 36 are arranged on the reflector 20.

The shifting structure 32 comprises two connecting lines 38 and two inductive lines 40.

Each of the radiation structures 26 of the corresponding dipole is associated with one of the connecting lines 38, one of the inductive lines 40 and one of the balun ground portions 37. Thus, the associated balun ground portion 37, the associated connecting line 38 and the associated inductive line 40 are electrically connected to one another and to the respective radiation structure 26.

The connecting lines 38 and the inductive lines 40 are in particular identical, but mirrored. In the following, it is referred to only one set of a radiation structure 26 and the associated connecting line 38, inductive line 40 and balun ground portion 37.

The connecting line 38 is located on the signal surface S and extends from the balun structure 30 upwards to the radiator head 22. It electrically connects the balun structure 30 with the radiation structures 26 of the associated dipole.

Parts of the connecting line 38 may be located on the radiator head 22. In this case, the shifting structure 32 is located partly on the support and partly on the radiator head 22. In the shown embodiment, however, the shifting structure 32 is located fully on the support 24.

The connecting line 38 comprises a patch portion 42 constituting the lower end of the connecting line 38.

The patch portion 42 has a rectangular shape, in particular a square shape. For example, the lengths of the sides of the rectangular shape do not differ from one another by more than 30%.

From the patch portion 42 upwards, the remaining connecting line 38 extends in a line-shaped fashion, wherein the width of the line is broader than the width of the signal line 36 of the balun structure 30.

The patch portion 42 is located in the region of the balun ground portion 37 at least partly. Thus, as can be seen in FIGS. 4 and 5, the patch portion 42 and the associated balun ground portion 37 overlap with one another in a projection perpendicular to the carrier 28.

Thus, the patch portion 42 is capacitively coupled to the associated balun ground portion 37.

Further, at least portions of the signal line 36 of the balun structure 30, in particular the portion extending sideways, is located between the patch portions 42.

In the shown embodiment, the inductive line 40 is located at the ground surface G, i.e. on the opposite surface than the associated connecting line 38.

The inductive line 40 extends from the associated connecting line 38 at a first end in a single trace.

Starting from the first end, the inductive line 40 has an inductive portion 46 and then a coupling portion 48 before, at its second end, the inductive line is galvanically connected to the reflector ground plane of the reflector 20.

The second end is, for example, at the same level in the radiation direction R as the balun ground portions 37.

The first end of the inductive line 40 is located in the region of the patch portion 42. At the location of the first end, a via 44 extends through the carrier 28 and galvanically couples the first end to the patch portion 42, i.e. the connecting line 38.

In the inductive portion 46, the trace of the inductive line 40 extends in meanders. Thus, in the inductive portion 46 several parallel traces of the inductive line 40 are present.

Due to the parallel traces, the inductive portion 46 provides an inductivity.

From the inductive portion 46 the inductive line 40 extends downward towards the reflector 20.

In the last section before reaching the reflector 20, the coupling portion 48 is located. In the coupling portion 48, the inductive line 40 extends close to the associated balun ground portion 37.

The trace of the inductive line 40 extends parallel and close to the outer edge 50 of the balun ground portion 37 with a distance between the inductive line 40 and the edge 50 smaller than 1.5 millimeters and/or smaller than 1/100 of a wavelength of the average frequency of the first frequency band.

The other portions of the inductive line 40 are spaced further apart from the balun ground portion 37.

Thus, in the coupling portion 48, the balun ground plane 34 capacitively couples to the associated balun ground portion 37.

The inductive lines 40, in particular the coupling portion 48 are arranged on opposite sides of the balun ground plane 34 of the same support 24.

As such, the balun ground plane 34 and both balun ground portions 37 are located between the coupling portions 48 of the inductive lines 40.

During operation, a signal is fed to the signal line 36. The signal is balanced by the balun structure 30 and fed to the radiation structures 26 by the shifting structure 32 for generating a respective electromagnetic wave.

The balun structure 30 provides the necessary balancing for converting the unbalanced signal of the signal line 36 to a balanced signal needed by the radiation structures 26.

Further, the shifting structure 32 shifts the common mode resonance of the first radiators 18 to a frequency outside of the second frequency band. In other words, the first natural resonance (i.e. the resonance without a shifting structure) occurring at ¼ of the wavelength of the average frequency of the first frequency band is moved out of the second frequency band, thus improving signal quality.

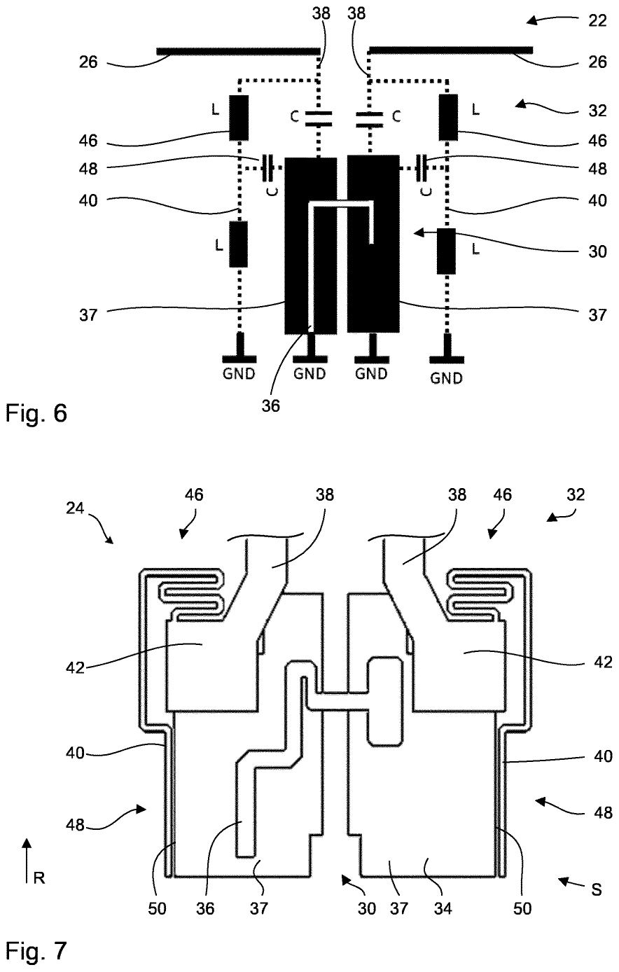

FIG. 6 shows a schematic circuit diagram representing the radiator 18, namely one dipole and one support 24 of the first radiator 18. Inductivities are labeled with the letter “L”, capacitances are labeled with the letter “C” and connections to the reflector ground plane of the reflector 20 are labeled with the letters “GND”.

As can be seen from FIG. 6, the balun structure 30 is connected to the radiation structure 26 by the connecting line 38 mainly providing a capacitance.

At the same time, the inductive line 40 provides an inductive coupling of the connecting line 38 to the reflector ground plane. Further, the inductive line 40 further provides a capacitance to the balun structure 30.

The shifting structure 32 is symmetrical with a bandwidth while, at the same time, providing a high degree of freedom for tuning and shifting the common mode resonance. Further, the shifting structure 32 is still compact and simple to manufacture.

FIG. 7 shows a support 24 in a view similar to that of FIG. 4 but of an antenna 14, 16 of a second embodiment of the invention. The second embodiment of the invention corresponds substantially to the first embodiment so that only the differences are discussed in the following. Same and functionally the same components are labeled with the same reference signs.

In the second embodiment, the inductive line 40 is not located at the ground surface G but at the signal surface S.

The first end of the inductive line 40 extends directly from the patch portion 42 of the connecting line 38.

The coupling portion 48 may extend, as discussed with respect to the first embodiment, in a small distance to the outer edge 50 but on the other surface than the outer edge 50.

It is also conceivable that the coupling portion 48 extends in the region of the associated balun ground portion 37, i.e. overlaps with the balun ground portion 37 in a projection perpendicular to the carrier 28.

In the second embodiment, the capacitive coupling between the inductive line 40 in the coupling portion 48 and the respective balun ground portion 37 then manifests through the material of the carrier 28.

In this design, manufacturing of the supports 24 is further simplified, as no via is necessary.

1. An antenna, in particular for a mobile communication base station, comprising a reflector, a first radiator having a radiator head and at least one support, as well as a second radiator;
wherein the radiator head comprises at least two radiation structures forming at least one dipole, the reflector comprises a reflector ground plane, and the support is mounted to the reflector and supports the radiator head above the reflector;
wherein the second radiator is mounted to the reflector;
wherein a balun structure and a shifting structure are provided at least partly on the support;
wherein the balun structure comprises a balun ground plane at the support and a signal line at the support; and
wherein the shifting structure electrically connects the balun structure to the radiator head, comprising a connecting line and an inductive line, wherein the connecting line is capacitively coupled to the balun ground plane and extending to the radiator head, and the inductive line extends from the connecting line to the reflector ground plane and provides an inductivity.

2. The antenna according to claim 1, wherein the balun ground plane comprises two separate balun ground portions and the shifting structure comprises two connecting lines and two inductive lines, wherein each radiation structure is associated with one of the connecting lines, one of the inductive lines and one of the balun ground portions, in particular wherein each radiation structure is electrically coupled to the associated connecting line, the associated connecting line being electrically coupled to the associated inductive line and the associated balun ground portion.

3. The antenna according to claim 2, wherein the signal line is capacitively coupled to both balun ground portions.

4. The antenna according to claim 1, wherein the connecting line comprises a patch portion capacitively coupled to the balun ground plane, in particular the associated balun ground portion.

5. The antenna according to claim 1, wherein the inductive line is galvanically coupled to the connecting line, in particular to the patch portion.

6. The antenna according to claim 1, wherein the inductive line comprises an inductive portion, in particular wherein the inductive line comprises parallel traces forming the inductive portion.

7. The antenna according to claim 1, wherein the inductive line comprises a coupling portion, the coupling portion being capacitively coupled to the balun ground plane, in particular to the associated balun ground portion.

8. The antenna according to claim 7, wherein the coupling portion comprises a trace extending parallel to an edge of the balun ground plane, in particular wherein the distance between the trace and the edge is smaller than 1.5 mm and smaller than 1/100 of a wavelength of an average frequency of a frequency band of the radiation structures.

9. The antenna according to claim 1, wherein the balun structure is located fully on the support or in part on the support and in part on the reflector; and that the shifting structure is located fully on the support or in part on the support and in part on the radiator head, in particular wherein the inductive line is located fully on the support.

10. The antenna according to claim 1, wherein the support comprises a carrier being a dielectric, in particular a foil or a printed circuit board, the carrier having two surfaces, wherein the balun structure and the shifting structure are applied to the surfaces of the carrier, in particular as metallizations.

11. The antenna according to claim 10, wherein the two surfaces are a ground surface and a signal surface, wherein the balun ground plane is provided on the ground surface, the connecting line of the shifting structure is provided on the signal surface, and the inductive line of the shifting structure is provided on the ground surface or the signal surface.

12. The antenna according to claim 10, wherein the inductive line is galvanically coupled to the connecting line by a via extending through the carrier.

13. The antenna according to claim 10, wherein the connecting line, in particular the patch portion, and the balun ground plane overlap in a projection perpendicular to the carrier.

14. The antenna according to claim 1, wherein the radiator comprises four radiation structures on the radiator head forming two dipoles, and two supports, wherein each support is associated with one of the dipoles, in particular wherein the supports are arranged perpendicular to one another.

15. The antenna according to claim 1, wherein the antenna comprises a plurality of first radiators forming at least one of a first array and a plurality of second radiators forming a second array.

16. A mobile communication base station comprising an antenna comprising a reflector, a first radiator having a radiator head and at least one support, as well as a second radiator:
wherein the radiator head comprises at least two radiation structures forming at least one dipole, the reflector comprises a reflector ground plane, and the support is mounted to the reflector and supports the radiator head above the reflector;
wherein the second radiator is mounted to the reflector;
wherein a balun structure and a shifting structure are provided at least partly on the support;
wherein the balun structure comprises a balun ground plane at the support and a signal line at the support; and
wherein the shifting structure electrically connects the balun structure to the radiator head, comprising a connecting line and an inductive line, wherein the connecting line is capacitively coupled to the balun ground plane and extending to the radiator head, and the inductive line extends from the connecting line to the reflector ground plane and provides an inductivity.

17. A user device for mobile communication comprising an antenna comprising a reflector, a first radiator having a radiator head and at least one support, as well as a second radiator:
wherein the radiator head comprises at least two radiation structures forming at least one dipole, the reflector comprises a reflector ground plane, and the support is mounted to the reflector and supports the radiator head above the reflector;
wherein the second radiator is mounted to the reflector;
wherein a balun structure and a shifting structure are provided at least partly on the support;
wherein the balun structure comprises a balun ground plane at the support and a signal line at the support; and
wherein the shifting structure electrically connects the balun structure to the radiator head, comprising a connecting line and an inductive line, wherein the connecting line is capacitively coupled to the balun ground plane and extending to the radiator head, and the inductive line extends from the connecting line to the reflector ground plane and provides an inductivity.
